(19) United States
(12) Patent Application Publication
(10) Pub. No.: US 2009/0039993 A1
(43) Pub. Date: Feb. 12, 2009

(54) Magnetic accessory system

(76) Inventor: Ariel Salvador Cudia, Arlington Heights, IL (US)

Correspondence Address: SARJU BHARUCHA, P.O. BOX 3932, NAPERVILLE, IL, 60567, US

(21) Appl. No.: 12/221,770

(22) Filed: Aug. 6, 2008

Related U.S. Application Data
(60) Provisional application No. 60/964,154, filed on Aug. 9, 2007.

(51) Int. Cl. H01F 7/00

(52) U.S. Cl. 335/285

(57) ABSTRACT

A lightweight and durable magnetic accessory system strengthened and secured by high-powered magnets to secure various accessories to magnetic surfaces. This invention is easily detachable and does not mar surfaces while maintaining its ability to securely fasten to anything that has magnetic qualities. The accessory is easy to clean and is versatile when used in a plurality of environments. The small size of the high-powered magnets allows the system to maintain a secure grip on magnetic surfaces as well as aiding in its highly aesthetic value. The simple connecting mechanism of the magnetic accessory system eases the burden of tedious construction and the need for a precise assembly.

### BACKGROUND OF THE INVENTION

A. Field of Invention

The present invention relates generally to foliage unit or units attached to a double magnetic base system to affix to magnetic surfaces.

B. Background

The current state of the art is plant systems consisting of artificial plants and flowers and that permanently affix to surfaces; and artificial plants and flowers that are constructed with magnets intended to attach to metallic surfaces. Existing inventions are not as adaptable; can be large and bulky; have tedious construction and are not as easily anchored.

The present invention is completely detachable and does not mar surfaces; it eases attaching/hanging decorative items using magnetic polarization; has an easy construction; is simple to move and relocate while being completely anchored once affixed; has great aesthetic value and is more affordable when compared to methods of affixing plants of its class.

### SUMMARY OF THE INVENTION

In accordance with one form of this invention, the foliage material is connected in a cascading formation with several branches attaching at one focal point. The distal end of the connected foliage is passed through the primary magnet. The primary magnet has a central whole providing for a plurality of stems to pass through. The stems are then melted and flattened to anchor the foliage material to the primary magnet. Then a second magnet is introduced to the system to polarize the two magnets and create a system by which the foliage can be connected to magnetic surfaces.

The system can be connected in several ways. One is connecting by the introduction of the primary magnet to one side of a magnetic surface while the secondary magnet is introduced directly opposing the primary magnet on the opposite side of the magnetic surface becoming affixed by a divided magnetic force. Another is connecting by introducing the primary and secondary magnets to each other and then introducing the magnetic duo to a magnetic surface as a whole.

### BRIEF DESCRIPTION OF THE DRAWINGS

In the following description, references will be made to the appended drawings, where like reference numerals refer to like elements in the various figures, and wherein:

FIG. 1 illustrates a fully assembled perspective view of a model of the present invention; and

FIG. 2 illustrates an exploded view of the structural components of FIG. 1.

### DETAILED DESCRIPTION OF THE PREFERRED EMBODIMENT OF THE INVENTION

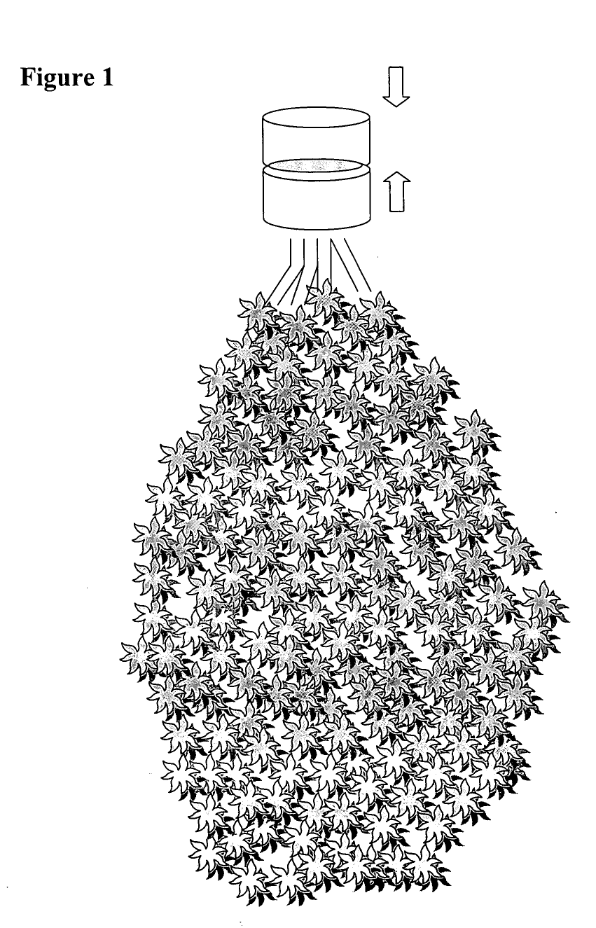

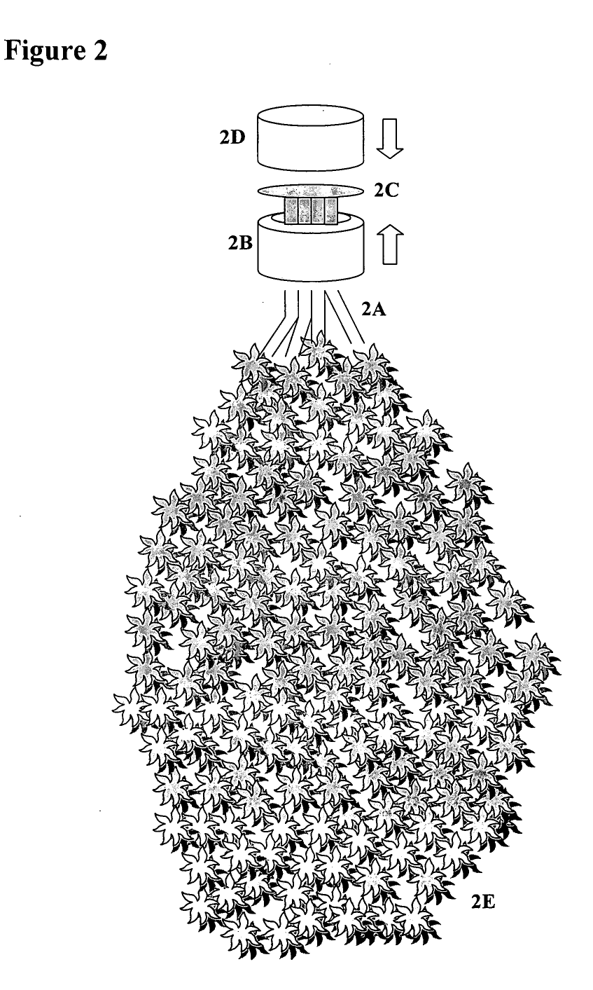

FIG. 1 is the forward perspective view of the magnetic foliage system. FIG. 2 is the exploded view of the structural components of the present invention. In FIG. 2, the foliage material 2E merges at one focal point 2A. The distal end or focal point 2A of the foliage material 2E is passed through the primary magnet 2B. The focal point 2A of the foliage material 2E is then melted and flattened 2C to anchor the foliage material 2E to the primary magnet 2B. Then a secondary magnet 2D is introduced to the system to polarize the primary magnet 2B and the secondary magnet 2D. The polarization of these two magnets creates a system by which the foliage 2E can be connected to magnetic surfaces.

We claim:

1. A magnetic accessory system, comprising:
a single or plurality of foliage units;
and a magnetic base system.

2. The structure as recited in claim 1, further comprising a single stem or plurality of stems.

3. The structure as recited in claim 1, wherein said plurality of stems are molded or melted forming a cluster or group of foliage units.

4. The structure as recited in claim 1, wherein said foliage units are constructed from varying materials, including natural, synthetic, artificial, silk, paper product, and plastic materials, and mixtures thereof.

5. The magnetic base system as recited in claim 1, wherein said base comprises a primary high-powered magnet, said single stem or plurality of stems and a secondary high-powered magnet.

6. The structure as recited in claim 5, wherein said primary high-powered magnet has a hollow center.

7. The structure as recited in claim 5, further comprising said primary high-powered magnet with a hollow center acting as primary housing for said stem or stems; said stem or stems are molded together by melting or by other adhesive means after passing through primary magnet and compressed to create a thin anchor for said stem or stems to affix to said primary high-powered magnet and secondary high-powered magnet is introduced to said thin anchor of molded or melted stem or stems to complete the magnetic base system.
